(19) United States
(12) Patent Application Publication
(10) Pub. No.: US 2025/0153497 A1
(43) Pub. Date: May 15, 2025

(54) TRANSFER FILM, COATING SYSTEM AND METHOD FOR TRANSFERRING IMAGES ONTO SUBSTRATES

(71) Applicant: FOREVER GMBH, Heddesheim (DE)

(72) Inventors: Vitali FENZEL, Neunkirchen (DE); Laurent BOUDIER, Mannheim (DE)

(21) Appl. No.: 18/840,028

(22) PCT Filed: Feb. 22, 2023
(86) PCT No.: PCT/EP2023/054379

§ 371 Date: Aug. 20, 2024

(30) Foreign Application Priority Data
Feb. 22, 2022 (DE) 10 2022 104 164.6

(51) Int. Cl. B41M 5/52; B41J 2/005; B41J 2/01; B41J 2/21; B41J 3/407; B41M 5/41; B41M 5/42; D06P 1/46; D06P 5/24; D06P 5/30

(52) U.S. Cl. CPC B41M 5/5254; B41J 2/0057; B41J 2/2117; B41J 3/4078; B41M 5/41; B41M 5/423; D06P 1/46; D06P 5/009; D06P 5/30; B41J 2002/012; B41M 2205/06; B41M 2205/36; B41M 2205/38; B41M 2205/42

(57) ABSTRACT

The present invention relates to a transfer foil for transferring images onto solid substrates (transfer printing), such as textile supports, in particular T-shirts, metallic supports or plastic, in particular signs, ceramic supports, in particular cups and plates, etc., comprising a two-dimensional carrier based on polyester, based on polyether ether ketones or based on a cellulose-based material, having a layer (a) which is arranged on at least one of the carrier surfaces and which is made of a cross-linked, at least partially hydrolysed polyvinyl alcohol (PVA) polymer, The present invention also relates to the use of same. A further subject matter of the present invention is a ready-to-use system for transfer printing, comprising a transfer foil and an image applied thereto, in particular printed thereon, and a hot melt adhesive.

The present invention relates to a transfer foil for transferring images onto solid substrates (transfer printing), such as textile supports, in particular T-shirts, metallic supports or plastic, in particular signs, ceramic supports, in particular cups and plates, etc. and to the use thereof. The invention also relates to a composition for coating transfer foils and a corresponding method for transferring images onto substrates. A further subject matter of the present invention is a coating system for transfer foils. A further subject matter of the present invention is a ready-to-use system for transfer printing, comprising a transfer foil and an image applied thereto, in particular printed thereon, and optionally a hot melt adhesive.

In the present case, transfer printing refers to the transfer of images onto solid substrates, such as textile supports, under elevated pressure and temperature conditions with the aid of so-called transfer papers or transfer foils, to which the image to be transferred is applied in advance, usually by printing with standard inks, toner inks, offset inks, flexographic inks or similar.

A relatively new system for transfer printing is the so-called direct-to-film (DTF) technology. As a rule, the image (motif) is applied mirror-inverted to a specially coated DTF transfer foil, usually polyester-based, in a single printing process using a CMYK inkjet printer, with the additional use of the colour white. In this case, the CMYK inks are printed first and then a white cover layer. Typically, 60% colour inks (CMYK) and 40% white ink are used. Commercially available special DTF inks are used, which are usually water-based pigment inks. After applying the image onto the transfer foil, a specialised hot melt adhesive that is typically polyurethane-based and usually in granulate or powder form is applied or spread, respectively, onto the printed DTF transfer foil. This can take place manually or via suitable finishing systems. Excess adhesive is typically shaken off. Afterwards, the hot melt adhesive is gelled and dried with the aid of heat. This is usually done by drying the printed foil treated with the adhesive in a drying device, such as a drying channel or an oven.

With the thus obtained ready-to-use DTF transfer foil, the image can be transferred to cotton, cotton blended fabrics, synthetic fibres such as nylon and polyester, but also to leather and solid materials using a heat transfer press or an iron. By using the white ink, the range of applications increases, since dark and coloured textiles can also be printed.

The ready-to-use DTF transfer foil obtained can however also be stored.

For transfer printing with DTF technology, so-called direct-to-garment (DTG) printers and corresponding DTG inks can also be used, which are actually intended for digital printing directly onto a pre-treated textile, usually cotton.

DTG transfer printing does not require the motifs to be weeded or the substrate to be pretreated. This is referred to as a self-weeding system.

Prints using DTF technology are characterised by high wash resistance (up to 60° C.) and high stretchability.

The known DTF transfer foils are based on a carrier based on polyester (carrier foil), in particular polyethylene terephthalate (PET), more particularly biaxially oriented polyester foils (BO-PET), and have an at least two-part coating consisting of a primer intermediate layer directly on the surface of the carrier/carrier foil with adhesion-promoting characteristics and a layer arranged thereon for the colour/ink absorption and release characteristics in relation to the image upon transfer. This layer is typically a so-called matte coating, i.e. the surface of the carrier coated with the matte coating is matte. A matte finish of the transferred image is achieved on the substrate when the image is transferred.

The primer layer can be created by chemical pretreatment of the carrier foil, such as treatment with trichloroacetic acid (TCA), 2-chlorophenol or ortho-chlorophenol, acrylic, polyurethane, polypropylene and similar, and/or co-extrusion on the foil surface. Examples of corresponding commercial products are Coveme Kemafoil® HPA, Normandy Coating Arcophane® TCA, Euroridel Ridelbond®, DuPont Teijin film Mylar® and Melinex®, JBF Aryafilm, Mitsu HOSTAPHAN®.

The present invention is based on the finding that an intermediate primer layer can be omitted by means of a novel composition of the layer for colour/ink absorption, optionally with release characteristics (in the following this layer is also referred to as a matte coating or layer (a)), wherein sufficient chemical adhesion of the matte coating is achieved directly on the surface of the carrier film, which leads to a considerably simpler structure of the transfer foil and thus to significant cost savings.

The invention provides a so-called self-weeding one-sheet system, wherein the transfer foil is printed with an image to be transferred, the printed transfer paper is arranged with the printed side on a substrate, the substrate with the transfer foil arranged thereon is subjected to the action of pressure and temperature, e.g. by means of a heat transfer press or an iron, the transfer foil is removed from the substrate in such a way that the unprinted areas remain on the carrier and the printed areas, i.e. the image, remain on the substrate. The removal of the carrier takes place in the cold, in the warm or hot state (so-called “cold peel”, “warm peel”, or “hot peel” respectively “instant peel”). In the cold state means that the removal takes place following the transfer process after a waiting time of at least 20 sec., preferably between 20 and 60 sec., in particular 20-30 sec. In the warm state means that the removal takes place after a shorter waiting time following the transfer process. The waiting time is typically up to about 15 sec., in particular about 5-15 sec. In the hot state means that the removal takes place directly after the transfer process. The removal/separation of the carrier advantageously takes place substantially in the range of the temperature of the pressing process or somewhat lower, in particular above the room temperature. Removal of the carrier in the hot state increases the efficiency of the transfer printing and enables a higher throughput and higher productivity.

Therefore, it is an object of the present invention to provide a simplified system and method for transferring images onto substrates, in particular for transfer printing based on DTF technology.

The present invention therefore relates to a transfer foil for transferring images onto substrates, comprising a carrier based on polyester, in particular polyethylene terephthalate (PET), more particularly a biaxially oriented polyester foil (BO-PET), having a layer (matte coating) arranged on at least one of the carrier surfaces. The carrier can alternatively be based on polyether ether ketones (PEEK) or on a cellulose-based material, such as non-woven fabrics, in particular based on cellulose fibres, such as coated or uncoated paper or cardboard, in particular uncoated paper, advantageously having a weight per unit area of e.g. about 80-150, preferably about 90-100 g/m², such as a machine finished paper suitable for (colour) copiers, (colour) laser printers or Inkjet printers. In the context of the present invention, “transfer foil” or “foil” comprises all aforementioned carrier materials. Preferably, the carrier consists of the aforementioned materials. More preferably, the carrier is a non-surface-treated biaxially oriented polyester foil (BO-PET). Such foils are commercially available, e.g. products of the Lumirror™ trademark, e.g. Lumirror™ 60.01 (company Toray Industries, Inc.) and products of the series Astroll® CD, e.g. CD900 (company Kolon industries, Inc.).

In the context of the present application, “carrier surface” is understood to mean the two-dimensional extent of the front or back side of a two-dimensional carrier, such as a foil sheet, paper sheet or a foil or paper roll. The term carrier surface does not relate to the cut edges.

According to the invention, an intermediate layer is not provided between the carrier surface and the matte coating. An uncoated foil thus serves as a carrier. In a further embodiment, the carrier surface can be subjected to an electromagnetic treatment, such as, for example, a plasma treatment, electron beam treatment or corona treatment.

The matte coating (layer (a)) is based on a cross-linked polyvinyl alcohol (PVA) polymer. The PVA polymer in the uncrosslinked state has a degree of hydrolysis of about 72-99 mol %, preferably about 72-95 mol %, particularly preferably about 72-90 mol-%, more preferably about 72-85 mol %, in particular about 72.5-75 mol % and a dynamic viscosity of about 2.5-55 mPa·s, preferably about 3.5-35 mPa·s, particularly preferably about 4-10 mPa·s. The degree of hydrolysis specifies what percentage of the acetate groups of the starting polymer polyvinyl acetate has been replaced by OH groups. The degree of polymerisation in the case of PVA is characterised by the dynamic viscosity [in millipascal·seconds (mPa·s)] of a four percent aqueous PVA solution. The degree of hydrolysis is determined according to ISO 15023-2:2019. The viscosity is determined via the determination of the Höppler viscosity according to DIN 53015 at 20° C. in 4% aqueous solution (Brookfield viscometer). Methods for determining further parameters are known to the person skilled in the art, such as the molecular weight by means of GPC according to DIN 55672-3:2007-0 and the degree of crystallinity in % by means of DSC according to DIN EN ISO 11357-7:2013-04.

Partially hydrolysed polyvinyl alcohols are preferred. Examples of commercial products that can be used are products of the Poval™ trademark of the company Kuraray Europe GmbH, such as Poval™ 5-74: viscosity 4.2-5.0 mPa s, degree of hydrolysis 72.5-74.5 mol % and products of the Gohensol™ trademark of the company Mitsubishi Chemical Corporation or NIPPON GOHSEI, such as Gohsenol™ NK-05R: viscosity 4.5-5.5 mPa s, degree of hydrolysis 71-75 mol %.

One or more polyvinyl alcohols can be used.

More preferably, the polyvinyl alcohol(s) are used in the form of aqueous solutions, e.g. 20 wt % based on the total weight of the solution.

Advantageously, the polyvinyl alcohol (as a 20 wt % aqueous solution) is used in the range of 5-50 wt %, preferably 6-40 wt %, more preferably 7-35 wt %, based on the total weight of the mixture to produce the matte coating.

Crosslinking agents or crosslinking systems for PVA are familiar to the person skilled in the art. According to the invention, one or more commercial crosslinking agents can be employed or incorporated by polymerization, such as dialdehydes, dicarboxylic acids, boric acids, borates and borax, epichlorohydrin, chlorohydrins. Preferably, the crosslinking agent is selected from the group containing glutaraldehydes, glyoxal, maleic acid, fumaric acid, malic acid, sulfosuccinic acid, phthalic acid, isophthalic acid, terephthalic acid, aconitic acid (cis, trans), citric acid and boric acid and the salts thereof, borates and hexamethylene diisocyanate, preferably maleic acid, fumaric acid, malic acid, sulfosuccinic acid, phthalic acid, isophthalic acid, terephthalic acid, aconitic acid (cis, trans), citric acid and boric acid and the salts thereof, more preferably phthalic acid, isophthalic acid, terephthalic acid, citric acid and boric acid and the salts thereof, particularly preferably citric acid and boric acid and the salts thereof.

One or more crosslinking agents can advantageously be employed in the range of 4-12 wt %, preferably 5-10 wt %, more preferably 6-8 wt %, based on the total weight of the mixture to produce the matte coating.

Optionally, additional co-crosslinking agents can be employed, for example melamine/formaldehyde resins, e.g. Knittex® CHN, or para-toluenesulfonic acid, chitin, chitosan and dextrose.

Advantageously, one or more co-crosslinking agents can be employed in the range of 0-10 wt %, preferably 1-8 wt %, more preferably 2-6 wt %, based on the total weight of the mixture to produce the matte coating.

Further optional components can be incorporated by polymerization into the PVA polymer that is employed or can be used in the manufacture thereof. Examples for optional components are additives for adjusting the porosity, e.g. polyamide 6/polyamide 12, wetting agents, e.g. silicone surfactants/siloxanes, such as commercial products of the brand “BYK”, additives for adjusting the viscosity, e.g. hydroxypropyl cellulose, cationic promoters, e.g. starch, polyamines, poly-DADMAC (polydiallyldimethyl ammonium chloride), e.g. Catiofast® BP liquid (company BASF SE), or metal complexes, such as Cr complexes, e.g. Quilon® products, such as Quilon® C, or Montacell® products, such as Montacell® CF, which are complexes of trivalent chromium with C₁₄-C₁₈ fatty acids, cationically modified silicic acid, salts, such as NH₄Cl; quaternised N-vinyl-2-pyrrolidone and dimethylaminoethyl methacrylate (DMAEMA) copolymer Viviprint® 650 or Gafquat® 755N, matting agents, e.g. organically treated amorphous synthetic silicic acid, additives with anionic functionality, such as e.g. anionically modified silicon dioxide, or waxes, such as optionally modified polyethylene wax, e.g. Lanco® wax, pigments, advantageously in an acrylate-based binder, and/or processing aids.

One or more optional components can advantageously be employed in the range of 0-50 wt %, preferably 0.5-25 wt %, more preferably 1-15 wt %, especially 1.5-7 wt %, based on the total weight of the mixture to produce the matte coating.

It has been shown that the use of one or more cationic promoters is particularly advantageous, in particular in the range of 0.5-10 wt %, preferably 1.5-8.5 wt %, more preferably 2-7 wt %, based on the total weight of the mixture to produce the matte coating.

The pigments are organic and/or inorganic and selected from colour pigments, glitter, metal pigments, functional pigments or mixtures thereof. For example, the pigment can be selected from multiple colour pigments. Functional pigments are understood to mean pigments with reflective, phosphorescent (glow-in-the-dark), fluorescent, photo-luminescent or similar optical characteristics.

Preferably, components have several functionalities. For example, a crosslinking agent can also function as a cationic promoter (e.g. epichlorohydrin, chlorohydrins, glyoxal, citric acid) or a co-crosslinking agent can also function as an additive to adjust the porosity (e.g. melamine/formaldehyde resin, aminopropyltriethoxysilane, chitin, chitosan, dextrose).

The matte coating is applied in a known wet coating method onto the carrier surface. For this purpose, the polyvinyl alcohol polymer is typically employed in the form of an aqueous solution, in particular about 20 wt % based on the total weight of the solution. The crosslinking component and one or more optional components are added. Advantageously, pre-mixtures can initially be formed, which are combined to form the finished mixture before application to the carrier surface.

The subject matter of the invention is therefore a transfer foil for transferring images onto substrates, comprising a two-dimensional carrier based on polyester, on polyether ether ketones or on a cellulose-based material, having a layer (a) which is arranged at least on one of the carrier surfaces and which is made from cross-linked, at least partially hydrolysed polyvinyl alcohol (PVA) polymer.

According to an advantageous embodiment, the matte coating comprises multiple, preferably two, layers (a) of the same or different composition, which are arranged on top of each other. The arrangement of multiple layers (a) of the same composition can be necessary due to production reasons in order to achieve a predefined total layer thickness of the matte coating. The arrangement of multiple layers (a) of a different composition can be appropriate, for example, when pigments, in particular glitter, metal pigments and/or functional pigments are added to the matte coating. In this case, the pigment-containing layer (a) is arranged above the layer (a), which is directly arranged on the carrier surface. The layer order according to the invention is, in this case, carrier surface→layer (a)→pigment-containing layer (a).

A transfer foil according to the invention, which is only provided with the matte coating (layer (a)), is also referred to as a 1-layer foil in the context of the present invention.

Preferably, the carrier foil consists of the carrier and the matte coating (layer (a)).

A further subject matter of the invention is a mixture for producing a matte coating and the use thereof for coating and/or for producing a transfer foil.

A mixture according to the invention for producing the matte coating typically comprises, based on the total weight of the mixture:
5-50 wt %, preferably 6-40 wt %, more preferably 7-35 wt % of polyvinyl alcohol (in the form of a 20 wt % aqueous solution),
4-12 wt %, preferably 5-10 wt %, more preferably 6-8 wt % of one or more cross-linking agents,
optionally 0-10 wt %, preferably 1-8 wt %, more preferably 2-6 wt % of one or more co-cross-linking agents,
optionally 0-10 wt %, preferably 1-8 wt %, more preferably 2-6 wt % of one or more additives for adjusting the porosity,
optionally 0.5-4 wt %, preferably 0.75-3 wt %, more preferably 1-2.5 wt % of one or more wetting agents,
optionally 0.5-10 wt %, preferably 1.5-8.5 wt %, more preferably 2-7 wt % of one or more cationic promoters,
optionally 0.5-8 wt %, preferably 1-6 wt %, more preferably 1-4 wt % of one or more additives with anionic functionality,
optionally 10-30 wt %, preferably 12-25 wt %, more preferably 17-20 wt % of one or more matting agents,
optionally 0-5 wt %, preferably 0.5-4.5 wt %, more preferably 2-3 wt % of one or more pigments.

The amounts of all the components of a mixture add up to 100 wt %.

The mixture for producing the matte coating is applied by brushing, squeegees or similar onto the carrier surface. Subsequently, a heat treatment of about 100 to 160° C., preferably about 120 to 150° C. is effected for about 15-60 sec., preferably about 15-30 sec. The drying advantageously takes place in a drying tunnel with multiple temperature zones, e.g. three zones, which have different temperatures, e.g. about 120° C., about 150° C. and about 130° C.

The obtained matte coating (layer (a)) has a layer thickness of about 1-15 g/m², preferably about 2-15 g/m², more preferably about 2-10 g/m², measured according to the so-called cut-out method. With this method, sections of e.g. 100 mm² size are removed from one or more positions of the material to be measured. In some cases, in which the weight of only a specific part of the material is to be determined, a separation is carried out by a chemical process or washing process with corresponding pre- and post-measurements of the weight.

The surface of the carrier opposite the matte coating (i.e. the back side of the carrier; the front side of the carrier is coated with the matte coating) can advantageously be equipped with a coating, e.g. silicone-based, which prevents stacked carriers from adhering to each other and thus facilitates storage.

An image can then be applied onto the obtained transfer foil (onto the matte coating (layer (a)), i.e. foil carrier with matte coating, advantageously by means of digital printing, laser printing, in particular by means of inkjet printing, (colour) copying or (colour) laser printing, with commercially available inks or toners being used for the respective printing technology.

As a rule, the image (motif) is applied mirror-inverted in a printing process onto the layer (a) of the transfer foil, preferably with the aid of a CMYK inkjet printer, with the additional use of the colour white. In this case, the CMYK inks are first printed and then a white cover layer.

In the meaning of the present invention, water-soluble or solvent-based inks, latex inks, DTF inks, DTG inks, polymer inks, so-called flexographic inks, screen printing inks, offset inks or similar are considered inks. Preferably, commercially available, special DTF inks, which are typically water-based pigment inks, are used to apply the image onto the transfer foil.

When using toners or sublimation inks, it is provided to apply a cover layer of screen printing inks over the toner layer/ink layer after application to the transfer foil. This layer of screen printing inks is typically a single-colour layer, such as a white layer, transparent layer or black layer.

After applying the image onto the transfer foil, a hot melt adhesive, typically polyurethane-based, in solid form, usually in granulate or powder form, is applied or spread, respectively, onto the printed foil, i.e. the side with the image. Typically, the adhesive is based on a thermoplastic polyurethane (TPU). Common parameters of the adhesive material are density: 1.20±0.02 g/cm³, melting point: 95-115° C., melting index: 30±7 g/10 min, powder size range: 80-200 μm, bonding temperature: 110-130° C., bonding time: 8-15 sec., wash resistance: 40-60° C. Such adhesives are commercially available, e.g. Gronal® Direct To Film adhesive capable of being spread.

Applying the adhesive can take place manually or via suitable finishing systems. The excess adhesive is removed, typically shaken off. During the transfer of the image onto a substrate, the hot melt adhesive comes into direct contact with the substrate surface and serves to adhere to the substrate.

Afterwards, the hot melt adhesive is gelled and dried with the aid of heat. This is usually done by drying the printed film treated with the adhesive in a drying device, such as a drying channel or an oven, at temperatures between about 110-150° C., preferably about 120-140° C., in particular 125-135° C., for a time of about 1-5 min., preferably about 1-3 min., in particular about 1.5-2.5 min.

In this manner, the ready-to-use system according to the invention is obtained for the transfer printing, comprising the transfer foil with the image applied thereon and the hot melt adhesive. This system is storable and can be used, when necessary, at a later time for the transfer of the image onto a substrate.

A system comprising or consisting of the transfer foil with the image applied thereon and the hot melt adhesive is also referred to as a 1-layer system in the context of the present invention.

Transferring the image onto a substrate with common devices, so-called thermal transfer presses or transfer presses or also irons, comprises
providing a transfer foil according to the invention and applying an image (motif) onto the matte coating, subsequently applying a hot melt adhesive onto the printed side of the foil and removing excess adhesive, or providing a ready-to-use system according to the invention for the transfer printing;
applying the system onto a substrate with the hot melt adhesive layer turned towards the surface of the substrate;
subsequently pressing the arrangement of substrate and system at about 2-5 bar in the temperature range of a minimum of about 100-120° C. to a maximum of about 180-200° C., for example, of about 100-200° C., particularly of about 110° C. to 160° C., in particular of about 130-150° C., typically for a minimum of about 15-20 sec. to a maximum of about 60 sec., in particular about 15-45 sec., preferably 15-30 sec., wherein the image is transferred onto the substrate; and
removing the carrier from the transfer foil in the cold, warm or hot state.

Depending on the layer structure of the matte coating and the composition of the layer(s) (a), the result of transfer printing using the 1-layer system with a matte coating and the image applied thereon as well as the hot melt adhesive leads to a glossy finish up to a matte finish of the transferred image on the substrate.

The 1-layer system according to the invention is in particular suitable for removal of the carrier in the cold state (so-called “cold peel”).

In a preferred embodiment of the present invention, a further layer, a so-called functional layer (layer (b)), is applied onto the matte coating (layer (a)). The layer order according to the invention is carrier surface→layer (a)→layer (b).

The layer (b) is made of one or more waxes. Appropriate waxes are familiar to the person skilled in the art in the field of transfer printing, such as mineral waxes, which are saturated hydrocarbons with a carbon number between 18 and 60, waxes from plants or animals, which belong to the group of compounds called cerides and are a subgroup of a larger group of substances called lipids; they are esters of fatty acids and fatty alcohols. Natural fatty acids are saturated or unsaturated, straight-chain carboxylic acids, of which the most important contain an even number of 12 to 22 carbon atoms; palmitic acid (or hexadecanoic acid C₁₆H₃₂O₂) with 16 carbon atoms is an example. Examples of vegetable waxes are carnauba wax, jojoba wax, candelilla wax, rice bran wax. Examples of animal waxes are beeswax and whalebone (or spermaceti). Carnauba wax, jojoba wax and candelilla wax and mixtures thereof are more preferred.

Advantageously, one or more waxes are used in the range of 5-50 wt %, preferably 10-40 wt %, more preferably 20-30 wt %, based on the total weight of the mixture to produce the functional layer.

The functional layer can contain optionally one or more additional components, such as release agents, e.g. synthetic waxes, such as PTFE-modified polyethylene wax (e.g. Lanco™ TF 1778, company Lubrizol) or polypropylene wax (Deuteron wax PP, company Deuteron GmbH), cationic promoters, e.g. starch, polyamines, poly-DADMAC, (polydiallyldimethyl ammonium chloride), e.g. Catiofast® BP liquid (company BASF SE), or metal complexes, such as Cr complexes, e.g. Quilon® products, such as Quilon® C, or Montacell® products, such as Montacell® CF, which are complexes of trivalent chromium with C₁₄-C₁₈ fatty acids, cationically modified silicic acid, salts, such as NH₄Cl; quaternised N-vinyl-2-pyrrolidone and dimethylaminoethyl methacrylate (DMAEMA) copolymer Viviprint® 650 or Gafquat® 755N, film formers, such as modified vinylpyrrolidone, e.g. copolymers of vinylpyrrolidone and dimethylaminoethyl methacrylate, optionally quaternised with diethylsulfate, or copolymers of vinylpyrrolidone and methacrylamidopropyltrimethyl ammonium chloride (MAPTAC), commercial product of the brand “Gafquat”, silicic acid, optionally organically modified, such as commercial products of the brand “Levasil”, additives with anionic functionality, such as e.g. anionically modified silicon dioxide, pigments, such as described above, and/or processing aids.

One or more optional components can be advantageously employed in the range of 0-95 wt %, preferably 5-70 wt %, more preferably 10-60 wt %, especially 15-50 wt %, based on the total weight of the mixture to produce the functional layer.

The functional layer is applied in a known wet coating method onto the carrier surface. For this purpose, one or more waxes are employed, typically in the form of an aqueous wax emulsion, in particular about 30 wt % based on the total weight of the emulsion. The one or more optional components are combined. Advantageously, premixtures can be formed initially which are combined to form the completed mixture before application to the carrier surface.

According to an advantageous embodiment, the functional layer comprises multiple, preferably two, layers (b) of the same or different composition, which are arranged on top of each other. The arrangement of multiple layers (b) of the same composition can be necessary due to production reasons, in order to achieve a predefined total layer thickness of the functional layer. The arrangement of multiple layers (b) of a different composition can, for example, be appropriate to set the desired characteristics, e.g. release characteristics, more specifically.

It has been shown that the transfer process of the image to be transferred to the substrate can be improved, in particular the image quality of the image to be transferred can be increased, if a further layer is arranged above the functional layer (b). According to a further advantageous embodiment, a further layer is arranged above the functional layer, particularly advantageously the further layer is a layer (a). The layer order according to the invention is carrier surface→layer (a)→layer (b)→further layer, preferably layer (a). In the event that the further layer is a layer (a), it can have the same or a different composition compared to the layer (a) arranged on the carrier surface. This further layer has a layer thickness of about 1-15 g/m², preferably about 2-15 g/m², more preferably about 2-10 g/m², measured according to the so-called cut-out method.

A transfer foil according to the invention, which is provided with the matte coating (layer (a)) and the functional layer (layer (b)), is also referred to as a 2-layer foil in the context of the present invention and is a further subject matter of the present invention.

Preferably, the 2-layer foil consists of the carrier, the matte coating (layer (a)) and the functional layer (layer (b)).

The 2-layer foil can advantageously have a further layer arranged above the functional layer (layer (b)). Preferably, this further layer is a layer a, more preferably a layer a of the same composition, such as the layer a, which is arranged directly on the carrier surface. The layer order according to the invention is carrier surface→layer (a)→layer (b)→layer (a).

A further subject matter of the invention is a mixture for producing a functional layer and the use thereof for coating and/or for producing a transfer foil, in particular in combination with a mixture for producing a matte coating.

A mixture according to the invention for producing the functional layer typically comprises, based on the total weight of the mixture:
5-50 wt %, preferably 10-40 wt %, more preferably 20-30 wt % of one or more waxes,
optionally 0-10 wt %, preferably 2-7.5 wt %, more preferably 3-6 wt % of one or more release agents,
optionally 1-20 wt %, preferably 5-15 wt %, more preferably 7.5-12.5 wt % of one or more cationic promoters,
optionally 0.5-8 wt %, preferably 1-6 wt %, more preferably 1-4 wt % of one or more additives with anionic functionality,
0-50 wt %, preferably 10-40 wt %, more preferably 20-30 wt % of one or more film formers,
optionally 0-25 wt %, preferably 2-17 wt %, more preferably 6-10 wt % of silicic acid, optionally organically modified,
optionally 0-12 wt %, preferably 2-10 wt %, more preferably 5-8 wt % of one or more pigments.

The amounts of all the components of a mixture add up to 100 wt %.

The functional layer is applied by brushing, squeegees or similar. Subsequently, a heat treatment of about 100 to 160° C., preferably about 120 to 150° C. takes place for about 15-60 sec., preferably about 15-30 sec. The drying advantageously takes place in a drying tunnel with multiple temperature zones, e.g. three zones, which have different temperatures, e.g. about 120° C., about 150° C. and about 130° C.

The mixture for producing the functional layer is applied by brushing, squeegees or similar onto the carrier surface. Subsequently, a heat treatment of about 100 to 160° C., preferably about 120 to 150° C. takes place for about 15-60 sec., preferably about 15-30 sec. The drying advantageously takes place in a drying tunnel with multiple temperature zones, e.g. three zones, which have different temperatures, e.g. about 120° C., about 150° C. and about 130° C.

The obtained functional layer has a layer thickness of about 1-15 g/m², preferably about 1-10 g/m², more preferably about 1-6 g/m², measured according to the so-called cut-out method.

If a functional layer (layer (b)) is provided on the matte coating (layer (a)), it is advantageous when the matte coating has cationic characteristics. This is achieved by using cationic promoters, e.g. starch, polyamines, poly-DADMAC (polydiallyldimethyl ammonium chloride), e.g. Catiofast® BP liquid (company BASF SE), or metal complexes, such as Cr complexes, e.g. Quilon® products, such as Quilon® C, or Montacell® products, such as Montacell® CF, which are complexes of trivalent chromium with C₁₄-C₁₈ fatty acids, cationically modified silicic acid, salts, such as NH₄Cl; quaternised N-vinyl-2 pyrrolidone and dimethylaminoethyl methacrylate (DMAEMA) copolymer Viviprint® 650 or Gafquat® 755N, as additional components of the matte coating.

If a functional layer is provided on the matte coating, it is likewise advantageous when the matte coating has a wetting agent as an additional component.

If a functional layer is provided on the matte coating, it has proven particularly advantageous when the matte coating also has anionic characteristics along with the cationic characteristics. This is achieved by using additional components with anionic functionality, such as anionically modified silicon dioxide.

If a functional layer is provided on the matte coating, it is similarly advantageous when the matte coating is free of citric acid or is produced without using citric acid.

An image can then be applied onto the obtained transfer foil, i.e. foil carrier with matte coating and functional layer, as described above for the transfer foil consisting of foil carrier and matte coating, wherein the image is applied onto the functional layer.

Likewise, the hot melt adhesive application and the heat treatment thereof take place, as described above for the transfer foil consisting of foil carrier and matte coating.

In this manner, a preferred embodiment of the ready-to-use system according to the invention is obtained for the transfer printing, comprising the transfer foil with matte coating, the functional layer with the image applied thereon, and the hot melt adhesive. This system is storable and can be used, when necessary, at a later time for the transfer of the image onto a substrate.

A further subject matter of the present invention is therefore a ready-to-use system for the transfer printing, comprising or consisting of the 2-layer foil with the image applied thereon and the hot melt adhesive, and is also referred to as a 2-layer system in the context of the present invention.

Transferring the image onto a substrate with common devices, so-called transfer presses or also iron, takes place as described above for the transfer foil consisting of the foil carrier and matte coating.

The result of the transfer printing using the 2-layer system with a matte coating, a functional layer and image applied thereon, and the hot melt adhesive, typically leads to a matte finish of the transferred image on the substrate.

The 2-layer system according to the invention is both suitable for removal in the cold state (“cold peel”), as well as in particular for removal of the carrier in the hot state (so-called “hot peel” or “instant peel”).

The system according to the invention is characterised by a high wash resistance of the transferred image. It is assumed that at least parts of the functional layer together with the image are transferred onto the substrate and so form a type of protective layer (top coating) on the image. This provides greater protection against washout.

The present invention also relates to the use of the transfer foil according to the invention.

The invention also relates to all combinations of preferred embodiments, as long as these are not mutually exclusive. The indications “about” or “approx.” in connection with a numerical indication mean that at least 10% higher or lower values or 5% higher or lower values and in any case 1% higher or lower values are included.

Unless otherwise stated or unless the context dictates otherwise, percentages refer to the weight, in case of doubt to the total weight of the mixture.

The invention will be explained with reference to the following examples, but without being limited to the embodiments specifically described.

Unless explicitly excluded, the use of the indefinite article “a” includes the meaning “one or more”.

### EXAMPLES

A. Production of a Transfer Foil with a Matte Coating

A non-surface-treated biaxially oriented polyester foil in DIN A4 format (commercial product Lumirror™ 60.01 (Toray Industries, Inc.)) is used as the carrier.

Mixtures for producing the matte coating are used in the following composition:

Mixture 1 (for 1-layer foil)

| Components | wt % |
|---|---|
| Boric acid | 0.10 |
| Citric acid (50%) | 1.92 |
| Melamine/formaldehyde resin (commercial product | 1.24 |
| Knittex ® CHN) | |
| Para-toluenesulfonic acid (35%) | 0.28 |
| Organically treated amorphous synthetic silicic acid | 9.04 |
| (commercial product (Syloid ® 161) | |
| Hydroxypropyl cellulose (commercial product | 1.24 |
| Klucel M or parameter) | |
| Silicone surfactant (commercial product BYK-348) | 0.71 |
| Polyether-modified, acrylic-functional | 0.24 |
| polydimethylsiloxane (commercial product | |
| BYK-3710) | |
| Partially hydrolysed polyvinyl alcohol | 21.65 |
| (in the form of a 20% aqueous solution, | |
| relative to the weight of the solution) | |
| (commercial product Poval ® 5-74) | |
| PTFE-modified, polyethylene wax, micronised | 2.86 |
| (commercial product Lanco ® TF 1778) | |
| Dextrose | 2.76 |
| H₂O | 57.96 |

Mixture 2a (for 2-layer foil)

| Components | wt % |
|---|---|
| Boric acid | 0.74 |
| Melamine/formaldehyde resin (commercial product | 5.92 |
| Knittex ® CHN) | |
| Para-toluenesulfonic acid | 0.66 |
| Organically treated amorphous synthetic silicic acid | 14.87 |
| (commercial product (Syloid ® 161) | |
| H₂O | 35.76 |
| Hydroxypropyl cellulose (commercial product Klucel M) | 0.24 |
| Silicone surfactant (commercial product BYK-348) | 1.18 |
| Polyether-modified, acrylic-functional polydimethylsiloxane | 0.39 |
| (commercial product BYK-3710) | |
| Partially hydrolysed polyvinyl alcohol (in the form of a 20% | 35.60 |
| aqueous solution, relative to the weight of the solution) | |
| (commercial product Poval ® 5-74) | |
| PTFE-modified, polyethylene wax, micronised | 4.76 |
| (commercial product Lanco ® TF 1778) | |

Mixture 2b (for 2-layer foil, in particular as layer (a) for a 2-layer foil with a further
layer, layer order: carrier surface → layer (a) → layer (b) → layer (a))

| Components | wt % |
|---|---|
| Boric acid | 0.07% |
| Citric acid (50%) | 2.61% |
| Melamine/formaldehyde resin (commercial product Knittex ® CHN) | 0.37% |
| Para-toluenesulfonic acid (35%) | 0.01% |
| Organically treated amorphous synthetic silicic acid (commercial | 14.19% |
| product (Syloid ® 161) | |
| Hydroxypropyl cellulose (commercial product Klucel M) | 0.37% |
| Silicone surfactant (commercial product BYK-348) | 1.12% |
| poly-DADMAC (commercial product Catiofast ® BP liquid) | 2.24% |
| Partially hydrolysed polyvinyl alcohol (in the form of a 20% | 2.80% |
| aqueous solution, relative to the weight of the solution) | |
| (commercial product Poval ® 5-74) | |
| Modified vinylpyrrolidone (commercial product Gafquat ®) | 1.31% |
| Dextrose | 0.19% |
| H₂O | 74.70% |

Mixture 1, 2a or 2b is applied by brushing onto the foil surface. Subsequently, a heat treatment takes place at about 120° C. for about 20 sec.

The matte coating obtained has a layer thickness of 3 g/m², measured according to the cut-out method, see above.

2. Production of a Transfer Foil with a Matte Coating and a Functional Layer (2-Layer Foil)

A functional layer was applied onto a transfer foil, obtained according to example 1, having a matte coating based on mixture 2a.

A mixture of the following composition was used to produce the functional layer:

Mixture 3

| Components | wt % |
|---|---|
| Organically modified silicic acid (commercial product | 5.17 |
| Levasil ® CC401) | |
| Wax emulsion based on carnauba wax (commercial | 21.55 |
| product AQUACER ® 2650) | |
| Complex of trivalent chromium with C₁₄-C₁₈-fatty acids | 5.17 |
| (commercial product Montacell ® CF) | |
| Silicone surfactant (commercial product BYK-348) | 0.86 |
| H₂O | 64.66 |
| Modified vinylpyrrolidone | 1.72 |
| (commercial product Gafquat ®) | |
| poly-DADMAC (commercial product | 0.86 |
| Catiofast ® BP liquid) | |

Mixture 3 is applied by brushing onto the matte coating. Subsequently, a heat treatment takes place at about 120° C. for about 20 sec.

The functional layer obtained has a layer thickness of 1 g/m², measured according to the cut-out method, see above.

### 2. Application Examples

A printer (DTF print system Kolibiri) of the company Print Equipment GmbH & Co. KG (DE) was used for the print (https://www.printequipment.de/detail/index/sArticle/3689).

For all of the test tests, inks (DTF Business Pro ink) of the company Print Equipment GmbH & Co. KG (DE) were used as ink (https://www.printequipment.de/dtf/dtf-verbrauchsmaterial/dtf-tinten/dtf-business-pro-tinte-kleinformat).

The material (DTF transfer powder) of the company Print Equipment GmbH & Co. KG (DE) was used as a hot melt adhesive (https://www.printequipment.de/dtf/dtf-verbrauchsmaterial/dtf-transferpudergranulat/dtf-transferpuder-zur-verwendung-mit-tinten-der-serie-industrial-ultra).

In the tests, a transfer press Insta 728 Heat Press of the company Insta Graphic Systems (US) was used (https://www.instagraph.com/shop/parts-accessories/model-728/insta-728/).

### 1. Instant Peel

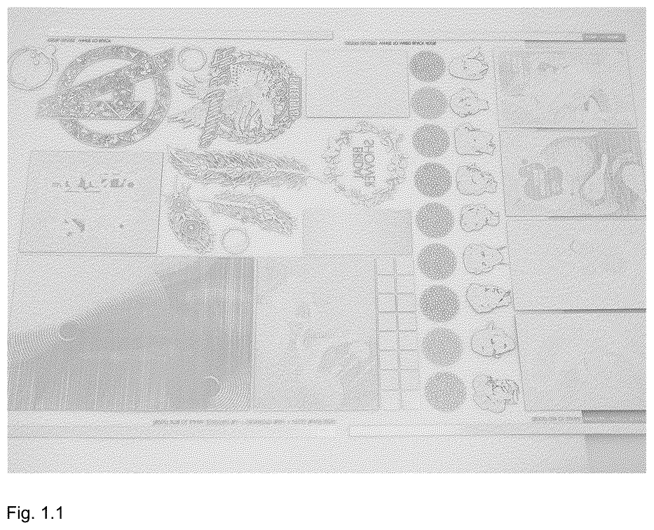

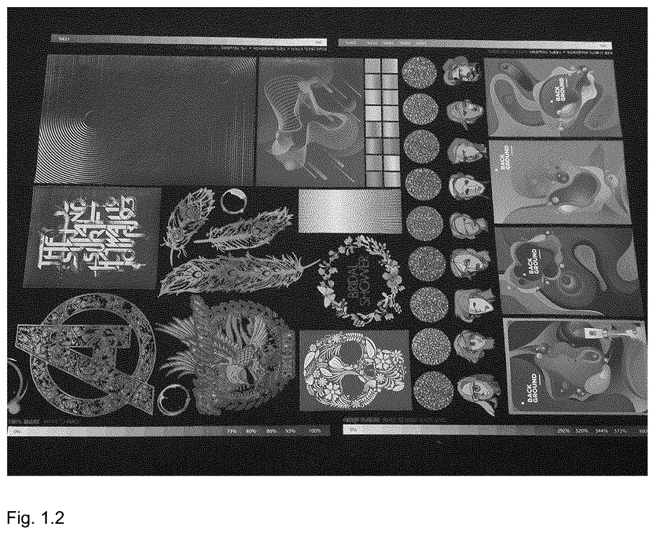

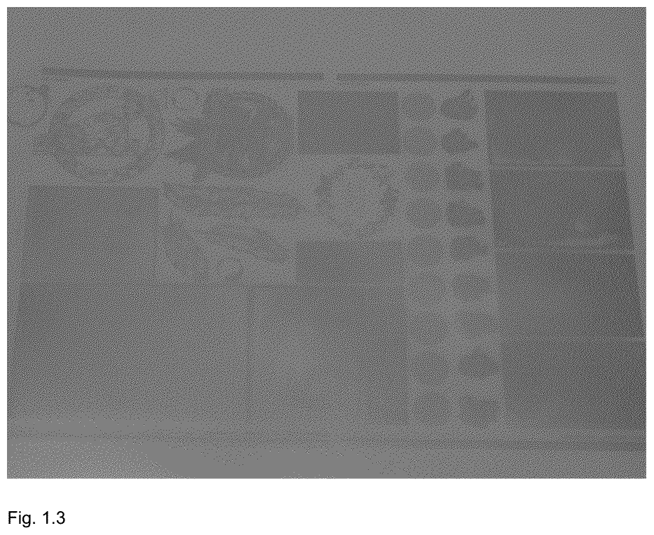

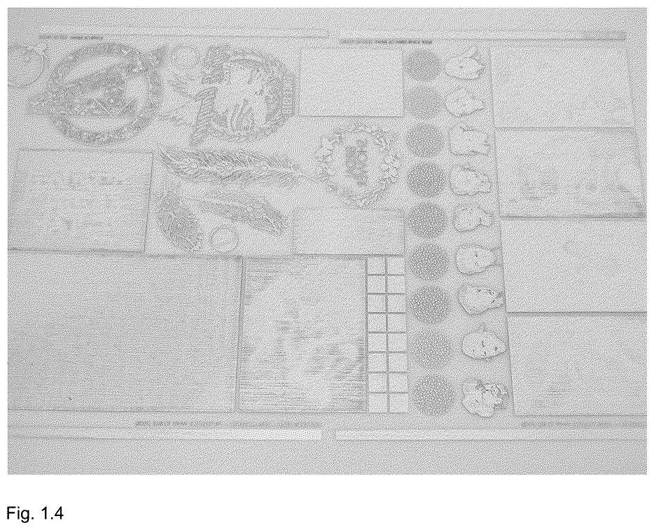

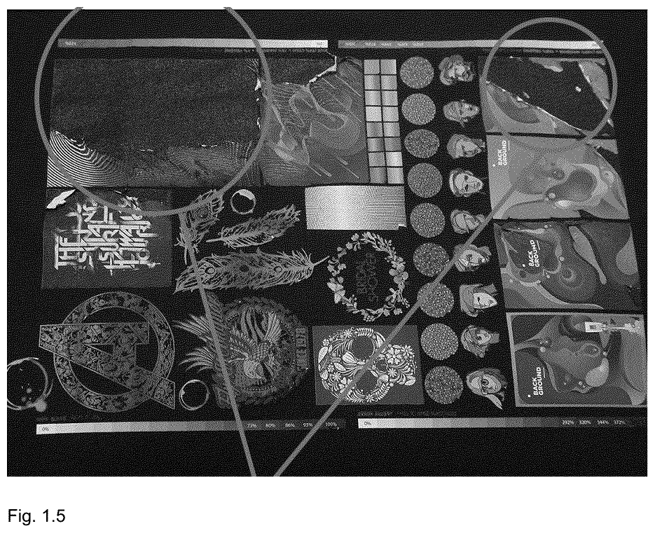

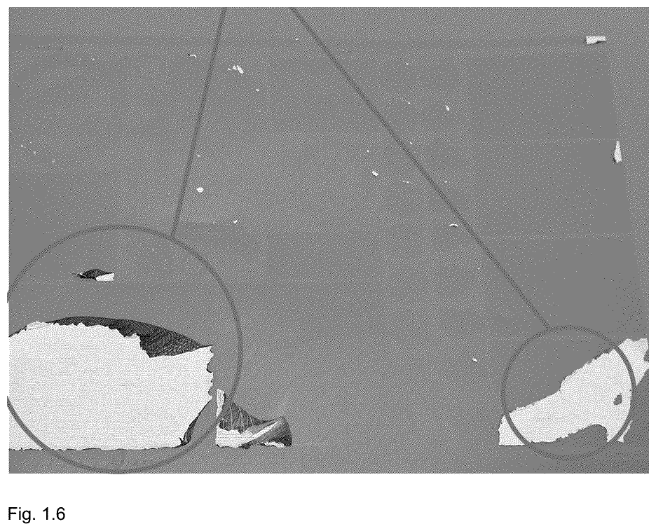

The carrier foil produced in accordance with preparation example A.2 (2-layer foil) was printed with an image (FIG. 1.1). Subsequently, the hot melt adhesive was applied and excess material was shaken off.

The hot melt adhesive was heat-treated or dried for 120 sec. at 135° C.

The thus obtained ready-to-use system according to the invention for the transfer printing (2-layer system) is applied with the hot melt adhesive side onto a textile (cotton) and is left in the transfer press for 20 sec. at 135° C. and 2 bar contact pressure.

The removal of the carrier takes place directly after the pressing process (instant peel).

The print result is shown in FIG. 1.2. A complete transfer of the image onto the substrate takes place. The transferred image has a matte finish.

The removed carrier is shown in FIG. 1.3. The surface of the removed carrier has a homogeneous structure.

For comparison, a commercial carrier foil DTF transfer foil Business Pro of the company Print GmbH & Co. KG (https://www.printequipment.de/dtf/dtf-verbrauchsmaterial/dtf-folien/dtf-transferfolie-business-pro) is used, which is a PET foil with an at least two-part coating made from a primer intermediate layer directly on the surface of the foil with adhesion promoter characteristics and a layer arranged thereon for the colour/ink absorption and release characteristics, and is printed with the same image (FIG. 1.4).

Subsequently, the hot melt adhesive was applied and excess material was shaken off.

The hot melt adhesive was heat-treated or dried for 150 sec. at 125° C.

The thus obtained ready-to-use system for the transfer printing is applied with the hot melt adhesive side onto a textile (cotton) and is left in the transfer press for 20 sec. at 150° C. and 2 bar contact pressure.

The removal of the carrier takes place directly after the pressing process (instant peel).

The print result is shown in FIG. 1.5. A complete transfer of the image onto the substrate does not take place, which can be seen in particular on the left and right upper corners of the substrate (see in particular circular markings in the Fig.). The transferred image has a matte finish.

The removed carrier is shown in FIG. 1.6. The surface of the removed carrier does not have a homogeneous structure. Parts of the image remaining on the carrier can be seen (see in particular circular markings in the Fig.).

The result shows that the 2-layer system according to the invention is suitable for a removal of the carrier in the hot state (hot peel or instant peel), while the comparable product is not suitable therefor.

### 2. Cold Peel

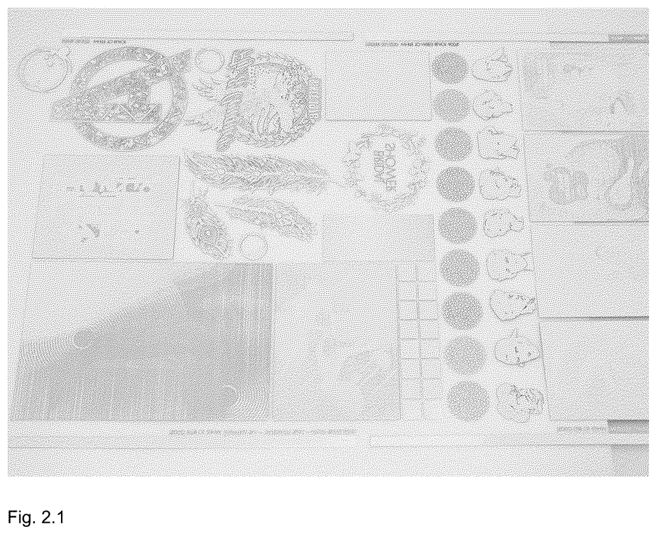

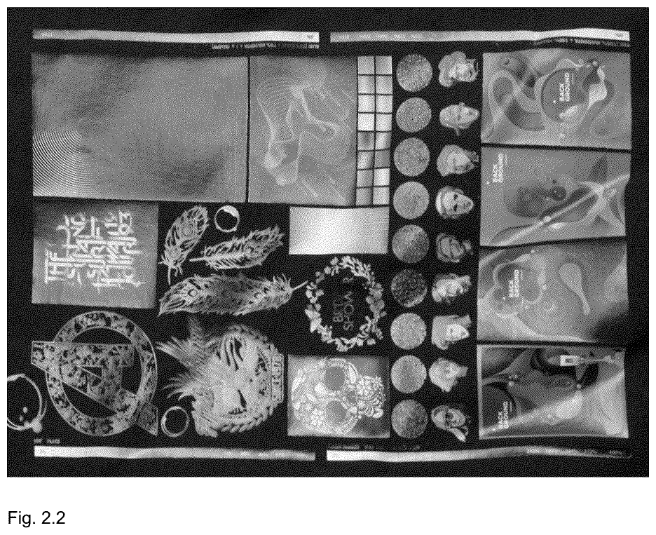

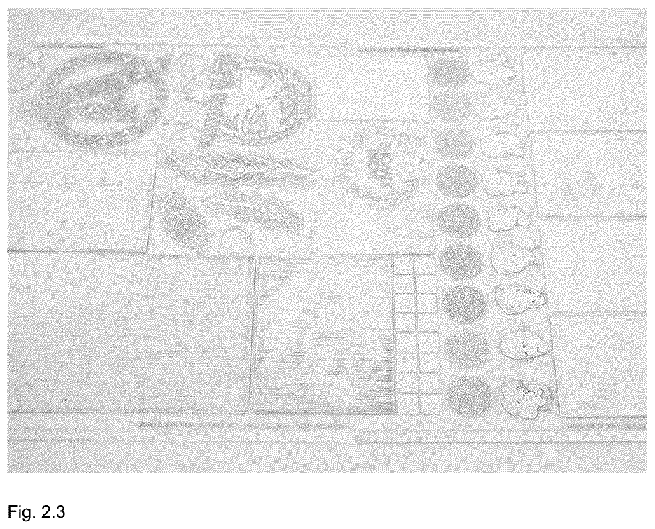

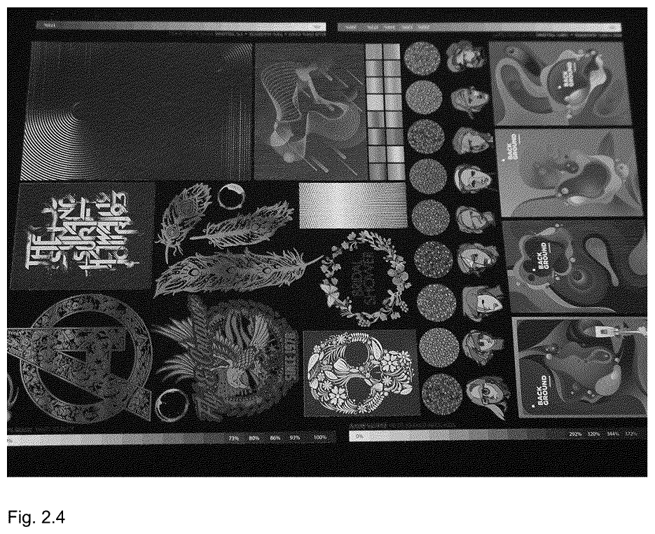

The carrier foil produced in accordance with preparation example A.1 (1-layer foil) was printed with an image (FIG. 2.1). Subsequently, the hot melt adhesive was applied and excess material was shaken off.

The hot melt adhesive was heat-treated or dried for 120 sec. at 135° C.

The ready-to-use system thus obtained according to the invention for the transfer printing (1-layer system) is applied with the hot melt adhesive onto a textile (cotton) and is left in the transfer press for 20 sec. at 135° C. and 2 bar contact pressure.

The removal of the carrier takes place in the cold state about 180 sec. after the pressing process (cold peel).

The print result is shown in FIG. 2.2. A complete transfer of the image onto the substrate takes place. The transferred image has a very glossy finish.

As comparison, analogously to the “instant peel” example, the commercial carrier foil DTF transfer foil Business Pro of the company Print Equipment GmbH & Co. KG is used (https://www.printequipment.de/dtf/dtf-verbrauchsmaterial/dtf-folien/dtf-transferfolie-business-pro) and printed with the same image (FIG. 2.3).

For the tests, the conditions (temperature, pressure, time) recommended by the manufacturer were selected.

Subsequently, the hot melt adhesive was applied and excess material was shaken off. The hot melt adhesive was heat-treated or dried for 150 sec. at 125° C.

The ready-to-use system is applied with the hot melt adhesive side onto a textile (cotton) and is left in the transfer press for 20 sec. at 150° C. and 2 bar contact pressure.

The removal of the carrier takes place in the cold state about 180 sec. after the pressing process (cold peel).

The print result is shown in FIG. 2.4. A complete transfer of the image onto the substrate takes place. The transferred image has a matte finish.

The 1-layer system according to the invention, despite a clearly simpler layer structure (in comparison to the known system), leads to a good transfer result.

Additionally, the system according to the invention (in comparison to the known system) leads to a glossy finish.

### 3. Image Quality

The quality of the transferred images is visually evaluated.

The comparative product achieved the best results when the carrier was removed in the cold state (according to test “2. cold peel”). The evaluation therefore takes place for the result of the 2-layer system according to the invention likewise after removing the carrier in the cold state (cold peel).

For this purpose, a carrier foil produced in accordance with preparation example A.2 (2-layer foil) was printed with an image. Subsequently, the hot melt adhesive was applied and excess material was shaken off.

The hot melt adhesive was heat-treated or dried for 120 sec. at 135° C.

The thus obtained ready-to-use system is applied with the hot melt adhesive side onto a textile (cotton) and is left in the transfer press for 20 sec. at 135° C. and 2 bar contact pressure.

The removal of the carrier takes place in the cold state about 180 sec. after the pressing process (cold peel).

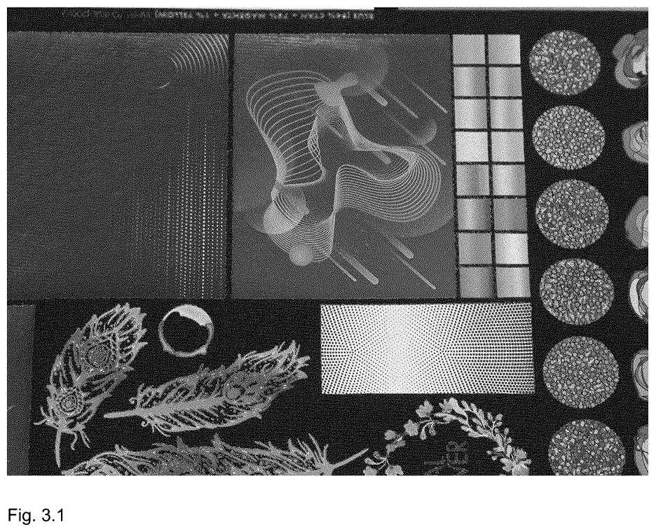

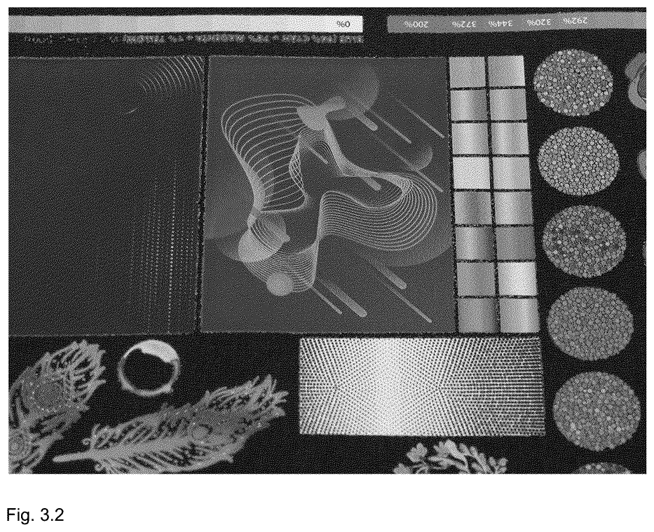

The print result is shown in FIG. 3.1. A complete transfer of the image onto the substrate takes place. The transferred image has a matte finish.

The transferred image according to the comparative system is shown in FIG. 3.2.

The image quality is equivalent.

The result shows that the system according to the invention, despite simpler layer structure, leads to an equivalent image quality in comparison with the best result of the known system for a removal of the carrier in the cold state.

### 4. Wash Resistance

Additionally, washing tests are carried out. For this purpose, the printed textiles are subjected to 20 wash cycles at 40° C. (washed directly after each other, wet-on-wet, for a total of 126 min.) using a commercial colour detergent (Persil Colour Powder).

The comparative product achieved the best results when the carrier was removed in the cold state (according to test “2. cold peel”). The evaluation therefore takes place for the result of the 2-layer system according to the invention likewise after removing the carrier in the cold state (cold peel).

A visual evaluation of the washing results takes place.

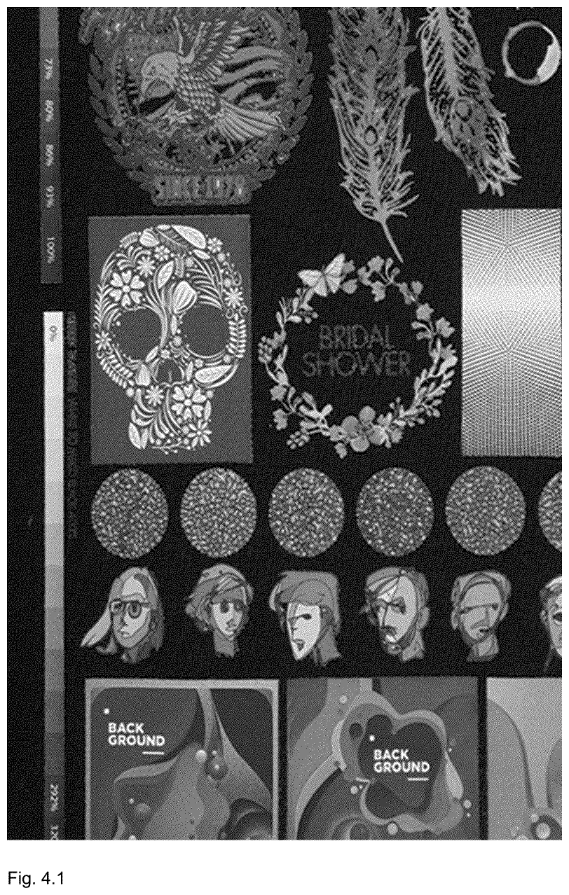

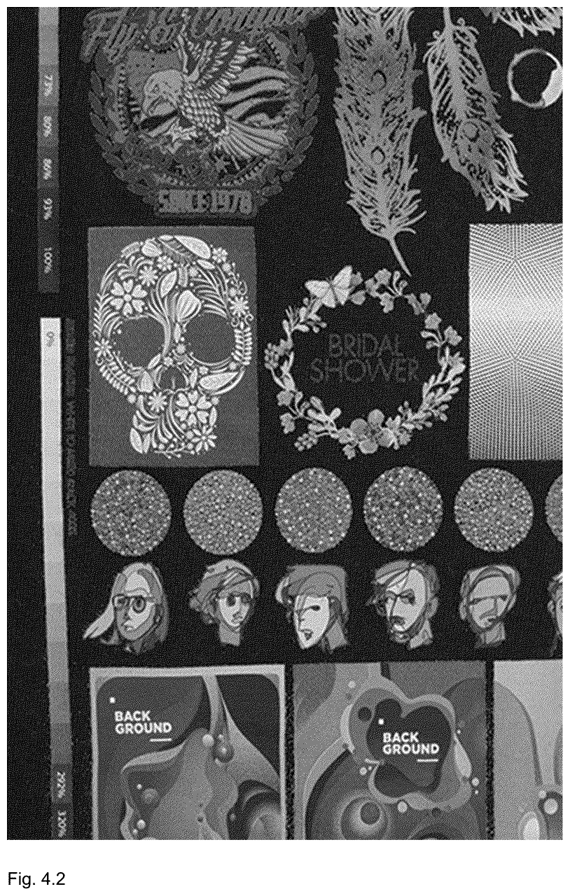

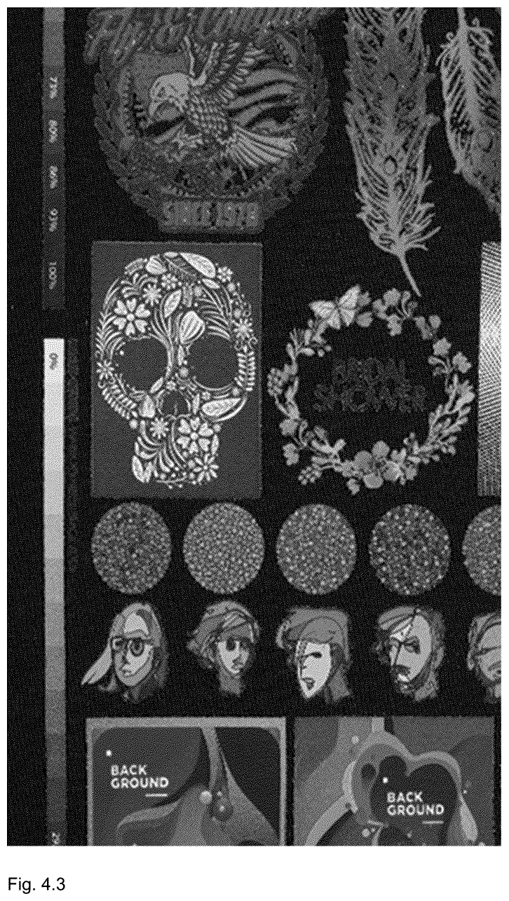

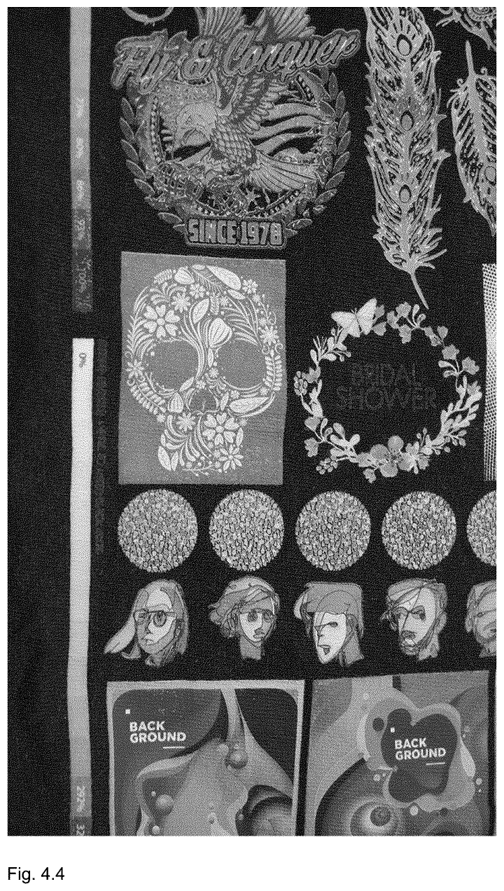

The image transferred onto the textile using the system according to the invention is shown in FIG. 4.1. The result after 20 wash cycles is shown in FIG. 4.2.

The image transferred onto the textile using the comparative system is shown in FIG. 4.3. The result after 20 wash cycles is shown in FIG. 4.4.

FIG. 4.2 only shows light washouts, while FIG. 4.4. shows more severe washouts.

The system according to the invention thus also leads to a higher wash resistance in comparison to the known system.

1. Transfer foil for transferring images onto substrates, comprising a two-dimensional carrier based on polyester, based on polyether ether ketones or based on a cellulose-based material, having a layer (a) which is arranged on at least one of the carrier surfaces and which is composed of a cross-linked, at least partially hydrolysed polyvinyl alcohol (PVA) polymer.

2. Transfer foil according to claim 1, wherein the PVA polymer in the uncrosslinked state has a degree of hydrolysis of about 72-99 mol %, preferably about 72-95 mol %, particularly preferably about 72-90 mol %, more preferably about 72-85 mol %, in particular about 72.5-75 mol % and a viscosity of about 2.5-55 mPa·s, preferably about 3.5-35 mPa·s, particularly preferably about 4-10 mPa·s.

3. Transfer foil according to claim 1, wherein one or more crosslinking agents selected from the group containing glutaraldehyde, glyoxal, maleic acid, fumaric acid, malic acid, sulfosuccinic acid, phthalic acid, isophthalic acid, terephthalic acid, aconitic acid (cis, trans), citric acid and boric acid and the salts thereof, borates and hexamethylene diisocyanate, preferably maleic acid, fumaric acid, malic acid, sulfosuccinic acid, phthalic acid, isophthalic acid, terephthalic acid, aconitic acid (cis, trans), citric acid and boric acid and the salts thereof and optionally one or more co-crosslinking agents selected from melamine/formaldehyde resins and 3-aminopropyltriethoxysilane are incorporated by polymerization into the PVA polymer.

4. Transfer foil according to claim 1, wherein the crosslinked PVA polymer has cationic characteristics.

5. Transfer foil according to claim 1, wherein additionally cationic promoters are incorporated by polymerization into the PVA polymer, preferably selected from starch, polyamines, metal complexes, cationically modified silicic acid and salts.

6. Transfer foil according to claim 1, wherein additionally one or more components which are incorporated by polymerization into the PVA polymer, selected from the group including additives for setting the porosity, wetting agents, additive for adjusting the viscosity, matting agents, additives with anionic functionality, pigments and processing aids are used.

7. Transfer foil according to claim 1, wherein the layer (a) has a layer thickness of about 1-15 g/m².

8. Transfer foil according to claim 1, wherein a plurality of, preferably two, layers (a) of the same or different composition are arranged one above the other.

9. Transfer foil according to claim 1, having a further layer (b) on the layer (a), wherein the layer (b) is composed of one or more waxes.

10. Transfer foil according to claim 9, wherein the wax is selected from carnauba wax, jojoba wax, candelilla wax, rice bran wax, beeswax, whalebone and a mixture thereof.

11. Transfer foil according to claim 9, wherein the layer (b) contains one or more additional components, selected from the group containing release agents, cationic promoters, film formers, silicic acid, optionally organically modified, pigments and processing aids.

12. Transfer foil according to claim 9, wherein the layer (b) has a layer thickness of about 1-15 g/m².

13. Transfer foil according to claim 9, wherein a further layer is arranged over the layer (b), preferably a layer (a).

14. Transfer foil according to claim 13, wherein the further layer (a) has the same composition as the layer (a) arranged directly on the carrier surface.

15. Transfer foil according to claim 8, wherein the layer (a) is free of citric acid.

16. Transfer foil according to claim 1, wherein the carrier is an uncoated foil.

17. Transfer foil according to claim 1, wherein the carrier is a biaxially oriented polyester foil (BO-PET).

18. Transfer foil according to claim 1, wherein the carrier surface is subjected to an electromagnetic treatment, preferably selected from plasma treatment or corona treatment.

19. Ready-to-use system for transfer printing, comprising a transfer foil according to claim 1 having an image applied onto the layer (a) or, if present, onto the layer (b) and a heat-treated hot melt adhesive applied onto the image.

20. System according to claim 19, wherein the image is applied with the aid of a CMYK inkjet printer, additionally using the colour white.

21. System according to claim 19, wherein the transfer printing is carried out according to the direct-to-film (DTF) technology.
